(19) United States
(12) Patent Application Publication
(10) Pub. No.: US 2005/0143239 A1
(43) Pub. Date: Jun. 30, 2005

(54) Plastic sleeve for a blanket cylinder and a method for producing the plastic sleeve

(76) Inventors: Steven O. Cormier, Green Bay, WI (US); Arun Chowdry, Pittsford, NY (US); Biao Tan, Penfield, NY (US)

Correspondence Address: Mark G. Bocchetti;Patent Legal Staff, Eastman Kodak Company, 343 State Street, Rochester, NY, 14650-2201, US

(21) Appl. No.: 11/017,047

(22) Filed: Dec. 20, 2004

Related U.S. Application Data
(60) Provisional application No. 60/532,181, filed on Dec. 23, 2003.

(51) Int. Cl. B25F 5/02; F16C 13/00

(52) U.S. Cl. 492/56; 29/895.3

(57) ABSTRACT

This invention relates to a plastic sleeve and a method for producing the plastic sleeve for use with a blanket cylinder in an electrophotographic process.

### FIELD OF THE INVENTION

This invention relates to a method for producing a plastic sleeve for use with a blanket cylinder in an electrophotographic process wherein the plastic sleeve requires no metal core.

### BACKGROUND OF THE INVENTION

In electrophotographic processes requiring an image cylinder and a blanket cylinder to produce electrophotographic copies, the image cylinder typically receives a charge, an image and a toner coating on the image area and then transfers the toner image to a blanket cylinder. The blanket cylinder transfers the toner image to a substrate, such as paper or the like, which passes via a web between the blanket cylinder and a back pressure roller to transfer the toner image to the substrate with the substrate thereafter being fused, as well known to the art.

In such processes, the blanket cylinder is a cylinder that typically includes a mandrel, which may be of aluminum, steel or any other suitably durable metal or conductive plastic of a suitable thickness to produce a noncompliant member that may be about 10 millimeters (mm) in thickness. The mandrel may include reinforcing structure internally and includes a very smooth low out-of-round tolerance exterior. The blanket cylinder includes a mandrel and a sleeve positioned over the outside of the mandrel and is used for transfer of the images from the blanket cylinder to a substrate. The mandrel also includes bearings connected to each of its ends for positioning it in an electrophotographic copying machine and has an air inlet into an interior of the mandrel for an air discharge through a plurality of holes placed around one end of the mandrel near a tapered end of the mandrel.

The sleeves have been produced by use of a metal core, which is typically a noncompliant metal member, such as nickel or the like, which is produced by plating. The core must be seamless and must provide a very low variation surface outer diameter. The plastic layer is then positioned around the outside of the metal core, the metal core is mounted on a mandrel or the like, and the plastic layer is machined to a desired thickness. Additional exterior coatings have been applied by techniques such as ring coating and the like. The completed sleeve will have an internal diameter slightly less than the outer diameter of the mandrel upon which it is to be placed. This interference fit allows the sleeve to be firmly positioned on the outside of the mandrel after it is installed. The sleeve must have a smooth exterior and a closely controlled wall thickness.

The sleeve is typically installed by urging it toward and onto the tapered end section of the mandrel while air is ejected through the holes at the end of the mandrel near the tapered section. The air injection permits the positioning of the sleeve on the mandrel by an air bearing technique as known to those skilled in the art. The interference fit between the sleeve and the mandrel is accomplished and the sleeve is retained snugly and firmly in position on the outside of the mandrel. The outside of the mandrel, including the sleeve, must have an outside diameter variation within a range of about ±12.5 microns. This close tolerance is necessary to ensure accurate receipt of images from the image cylinder and transmission of the images to the substrate by the blanket cylinder.

There are various other specific requirements for the blanket cylinder and it has been previously considered necessary to meet these other requirements as well as those discussed above by the use of a metal core in the sleeve. This is a relatively expensive, time-consuming step and the cores are relatively expensive. As a result, a continued effort has been directed to the development of methods for producing sleeves more economically that will meet the demanding requirements for the blanket cylinder sleeves.

### SUMMARY OF THE INVENTION

According to the present invention, plastic sleeves that do not include a metal core are produced for use with a blanket cylinder. Such sleeves are-produced by a method wherein a quantity of a liquid plastic or liquid plastic precursors are positioned in a mold having an inside and an outside and an inner diameter equal to the desired outer diameter of the sleeve, the quantity being a controlled amount sufficient to produce a sleeve on the inside of the mold having a selected wall thickness, rotating the mold at a velocity to produce a centrifugal force of at least about 5 times the force of gravity at the inside of the mold until the plastic has solidified, heating the mold to a temperature from about 20 to about 100° C. during rotation of the mold and removing the sleeve from the mold, the sleeve having a wall thickness from about 1 to about 20 mm.

The invention further includes a sleeve for use by positioning the sleeve over an outer diameter of a mandrel to form a blanket cylinder, the sleeve consisting essential 14 of a plastic sleeve having a wall thickness from about 1 to about 20 mm, an inner diameter smaller than the outer diameter of the mandrel, a Shore A hardness of about 60±5, and a wall thickness variation of no more than about ±12.5 microns from the average wall thickness.

### BRIEF DESCRIPTION OF THE DRAWINGS

FIG. 1 shows an embodiment of a process and system wherein a blanket cylinder according to present invention is used;

FIG. 2 is a schematic diagram of a mandrel and a sleeve, with the sleeve being positioned for installation on the mandrel;

FIG. 3 is a schematic diagram of a sleeve positioned on the mandrel; and

FIG. 4 is a schematic diagram of a mold positioned for rotation and injection of plastic material to form a plastic sleeve according to the present invention.

### DESCRIPTION OF PREFERRED EMBODIMENTS

In the description of the figures, the same numbers will be used to refer to the same or similar components throughout in the discussion of the figures.

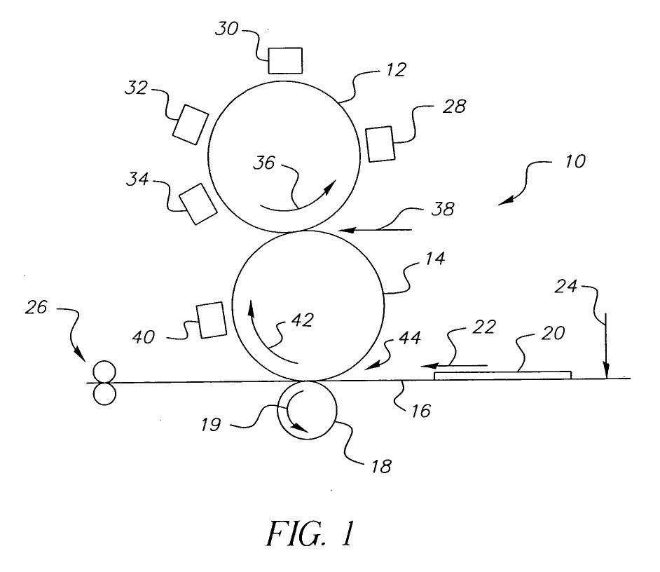

In FIG. 1, an electrophotographic process and system 10 are shown. The process includes a blanket cylinder 12 positioned in engagement with a blanket cylinder 14, which is positioned in engagement with a web 16 and a back pressure roller 18. A substrate 20, which may be paper or the like, is passed along a web 16 between blanket cylinder 14 and back pressure roller 18. The substrate, now bearing an image, is passed along web 16 to a fuser section 26 where it is fused as known to those skilled in the art. The direction of travel of the substrate is shown by arrow 22. A sensor 24 is positioned to ensure that substrate 20 passes in contact with blanket cylinder 14 at a proper time so that the image is properly positioned on substrate 20.

In the operation of the process, image cylinder 12 rotates in a direction shown by arrow 36 and blanket cylinder 14 rotates in a direction shown by arrow 42. Back pressure roller 18 turns in a direction as shown by arrow 19. A nip 38 is formed between image cylinder 12 and blanket cylinder 14. The nip is typically about 4.5±1 mm in width. Similarly, a nip is formed between blanket cylinder 14 and back pressure roller 18. This nip is about 4 to about 10 mm in width. A cleaning station 28 is positioned to contact the surface of image cylinder 12 after it passes nip 38. The clean cylinder surface then passes a charger station 30, a writer station 32 where an electrostatic image is placed on the surface of cylinder 12 and a toner section 34 that applies toner to the electrostatic image, which is then transferred at nip 38 to blanket cylinder 14. Blanket cylinder 14 transfers the image to substrate 20 and is thereafter cleaned by a cleaner 40 to ensure that a clean surface is provided on blanket cylinder 14 for transfer of an additional image from image cylinder 12.

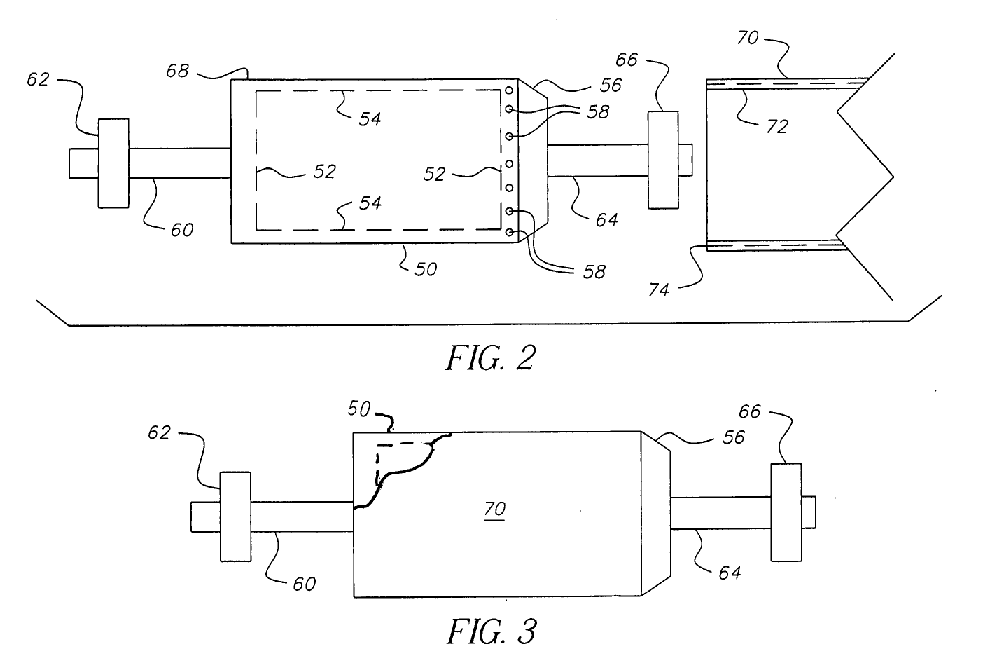

Image cylinder 12 and blanket cylinder 14 are both of similar construction, although the materials and properties of their exteriors are different. As shown in FIG. 2, blanket cylinder 12 is a mandrel 50 that has side walls 54 and ends 52 and includes a tube 60 which supports a bearing 62 in operative engagement with one end of mandrel 50 and a shaft 64 which supports a second bearing 66 in operative engagement with the other end of mandrel 50.

Tube 60 is adapted for the injection of air into mandrel 50, which includes near one of its ends, a taper 56, and a plurality of air holes 58. These air holes are used for the ejection of air during the installation of a sleeve over mandrel 50. Mandrel 50 has an outside diameter 68, which is somewhat larger than the inner diameter 72 of a sleeve 70. Sleeve 70 as shown, is a plastic sleeve according to the present invention. Its end 74 is urged into engagement with tapered section 56 of mandrel 50 and the sleeve is placed over an outside diameter 68 of mandrel 50 by an air step process using the ejection of air through holes 58.

In FIG. 3, an installed sleeve, according to the present invention, is shown on mandrel 50. The mandrel and sleeve that comprise blanket cylinder 14 are now assembled.

The blanket cylinder may have a diameter from about 2 cm to about 400 cm. While the diameter may vary widely, the variations in mandrel diameter or the out of round run out must be limited to ±12.5 microns. This is necessary to ensure that the proper nip is achieved with the blanket cylinder and the image cylinder and that good image transfer from the image cylinder to the blanket cylinder and from the blanket cylinder to the substrate is accomplished.

Desirably the outside of sleeve 70 has a Shore A hardness of about 60±5. The hardness is readily varied by changing the formulation of the plastic, as well known to those skilled in the art. The thickness of the sleeve wall may be from about 1 to about 20 mm. The sleeve wall is plastic and is rigid enough to handle. Further the plastic desirably has a conductivity of at least 10⁸ to 10¹⁴ ohms·cm. Generally the conductivity of the blanket cylinder sleeve is less than for the image cylinder sleeve, although the charge on the blanket cylinder is typically higher than that on the image cylinder. To produce an acceptable exterior surface on blanket cylinder 14, it is necessary that the wall thickness of the sleeve be held to a thickness variation of ±12.5 microns. Generally the blanket cylinder sleeve exterior is more compliant than the exterior of the image cylinder sleeve.

Sleeves have been formed in the past by positioning the sleeves on a seamless metal core typically formed by plating. The metal core provided support for the positioning of the plastic around the metal core and then the plastic was machined to the required size. Both the requirement for the metal core and the requirement for machining represent expensive and time consuming operations that have been required to achieve the precision necessary to produce the sleeves for the blanket cylinder.

As well known to those skilled in the art, a thin hard release layer such as a sol-gel, a ceramer or a fluoropolymer may be placed on the outside of the sleeve for the blanket cylinder. This layer has been applied by processes such as ring coating. It is also known that inorganic or organic layers may be applied over the outside of the sleeve to modify surface properties such as surface energy. The use and application of such outer layers is not considered to constitute part of the present invention, which is directed to the production of a sleeve for a blanket cylinder meeting the exacting requirements for such a sleeve.

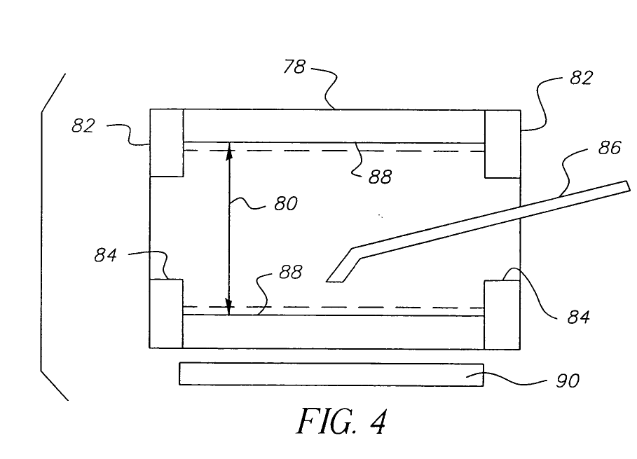

According to the present invention, such sleeves are readily produced by a method wherein a quantity of plastic precursors, a suitable liquid plastic, or liquefiable plastic are positioned in a mold with the mold then being heated by a heater 90 to a suitable temperature to result in the presence of the plastic in the mold in a liquid form. A suitable mold is shown schematically in FIG. 4. The mold has a wall 78 and ends 82. Openings 84 are generally left in the ends. While the plastic could be introduced in a number of ways, it is shown as being introduced through a tube 86 that supplies a quantity of plastic suitable to form a sleeve of the desired thickness and of uniform thickness in the mold. The uniformity is achieved by spinning the mold while the plastic is heated and as the plastic moves through a molten phase. The molding may be done with a thermoplastic material, which after liquefying is allowed to cool back into a hardened phase. In any event, the formation of the solid sleeve is accomplished with rotation of the mold at a rate sufficient to produce a centrifugal force equal to at least five and preferably at least about 10 and desirably from about 5 to about 100 times the force of gravity at the inside of the mold until the plastic has solidified.

Suitable plastics include thermoplastic, thermosetting and elastomeric plastics and particularly polyurethanes are preferred. With polyurethanes, polymer precursors may be placed into the mold and allowed to polymerize, cross-link and otherwise react to form the desired plastics as the mold spins. Polysiloxanes may also be used. In any event, it has been found that when the inside of the mold is formed to have a surface within the required variations for the outside of the sleeve, that the inside of the sleeve and the sleeve wall thickness can be produced to sufficiently close tolerances by this method to enable its positioning over a mandrel and use on the blanket cylinder.

The heating and cooling of the mold may be at rates deemed suitable for the particular plastic used and desirably the rotation of the mold is continued until the plastic has reached a temperature of about 100° C. and thereafter until the plastic is cooled to a temperature selected for convenience in handling and the like. After cooling the sleeve typically releases from the inside of the mold by contraction of the plastic so that the sleeve is readily removed from the mold by simply removing one of ends 82 and removing the sleeve. The sleeve is then ready for use or for coating with additional materials that may be desired on its exterior. A heater 90 is shown but it will be understood that any suitable type of heater can be used.

By the process of the present invention, sleeves for the blanket cylinder can be produced much more economically and more efficiently than with previously used methods. The sleeves produced consist essentially of a plastic sleeve for use by positioning it over an outer diameter of a mandrel. The plastic sleeve has a wall thickness from about 1 to about 20 mm, an inner diameter smaller than the outer diameter of the mandrel, a Shore A hardness of about 60±5 and a wall thickness variation of no more than about ±12.5 microns from the average wall thickness. These sleeves are highly desirable as replacement sleeves around the outside of mandrels in blanket cylinders. These sleeves are also much more economically produced while providing sleeves of an equivalent or superior quality to those produced by prior art methods.

As well known to those skilled in the art, it is desirable in some instances to modify the surface energy properties of the blanket cylinder sleeve. This may be readily accomplished by coating a suitable surface energy modifying material onto the surface of the sleeve. This may readily be done by ring coating or the like.

While the present invention has been described by reference to certain of its preferred embodiments, it is pointed out that the embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

1. A method for producing a plastic sleeve for use with a blanket cylinder in an electrophotographic process, the method comprising:
a. positioning a quantity of a solid or a liquid plastic or liquid plastic precursors in a mold having an inside and an outside and an inner diameter equal to the desired outer diameter of the sleeve, the quantity being a controlled amount sufficient to produce a sleeve on the inside of the mold having a selected wall thickness;
b. rotating the mold at a velocity to produce a centrifugal force of at least about 5 times the force of gravity at the inside of the mold until the plastic has solidified;
c. heating the mold to a temperature from about 20 to about 100° C. during rotation of the mold; and
d. removing the sleeve from the mold, the sleeve having a wall thickness from about 1 to about 20 mm.

2. The method of claim 1 wherein the plastic sleeve is conductive.

3. The method of claim 1 wherein the blanket cylinder has a diameter from about 2 cm to about 400 cm.

4. The method of claim 1 wherein the plastic is a rigid polyurethane plastic.

5. The method of claim 1 wherein the plastic is a thermoplastic plastic.

6. The method of claim 1 wherein the plastic is a thermosetting plastic.

7. The method of claim 1 wherein the sleeve is formed of liquid plastic constituents in the mold.

8. The method of claim 1 wherein the sleeve has a Shore A hardness of about 60±5.

9. The method of claim 1 wherein the sleeve has a wall thickness variation of no more than ±12.5 microns from the average wall thickness.

10. The method of claim 1 wherein the mold is cooled to a selected temperature during rotation of the mold prior to removing the sleeve.

11. The method of claim 1 wherein the centrifugal force is from about 5 to about 10 times the force of gravity.

12. A sleeve for use by positioning over an outer diameter of a mandrel to form a blanket cylinder, the sleeve consisting essentially of a plastic sleeve having:
a. a wall thickness from about 1 to about 20 mm;
b. an inner diameter smaller than the outer diameter of the mandrel;
c. a Shore A hardness of about 65±5; and
d. a wall thickness variation of no more than about ±12.5 microns from the average wall thickness.

13. The sleeve of claim 12 wherein the plastic is a rigid polyurethane plastic.

14. The sleeve of claim 12 wherein the plastic is a thermoplastic plastic.

15. The sleeve of claim 12 wherein the plastic is a thermosetting plastic.

16. The sleeve of claim 12 wherein the inner diameter of the sleeve is smaller than the outer diameter of the mandrel.

17. The sleeve of claim 12 wherein the plastic sleeve has a conductivity of about 8 to about 10¹⁰ ohms·cm.
